(19) United States
(12) Patent Application Publication
(10) Pub. No.: US 2015/0260393 A1
(43) Pub. Date: Sep. 17, 2015

(54) Audio Equipment and Bracket for Linear Lighting Device Thereof

(71) Applicant: Yamaha Corporation, Hamamatsu-shi (JP)

(72) Inventor: Yasuyoshi GOTOU, Hamamatsu-shi (JP)

(21) Appl. No.: 14/644,422

(22) Filed: Mar. 11, 2015

(30) Foreign Application Priority Data
Mar. 12, 2014 (JP) 2014-048644

(51) Int. Cl. F21V 33/00; F21V 8/00

(52) U.S. Cl. CPC F21V 33/0056; G02B 6/0008; F21Y 2101/02

(57) ABSTRACT

A linear opening is formed in a front wall portion of a housing of an audio equipment, and a bracket retaining a linear light guide member is installed on a rear side of the front wall portion such that at least one side of the light guide member is exposed at the opening. Both ends of the light guide member extend in the bracket in a direction away from the opening, and an LED as a light source is connected to each end via a coupler. Accordingly, noise generated at the LED light source is less likely to leak outside from the housing of audio equipment.

### BACKGROUND

The invention relates to an audio equipment having a linear lighting device on an outer surface of a housing and to a bracket for the linear lighting device of the audio equipment.

It is known in the convention art that, in addition to lamps having round shapes or square shapes, lighting devices having linear shapes that are provided along a contour of a part of an outer face of a vehicle or the like. Such linear lighting devices not only serve their primary function as lighting devices but also enhance designability. For example, Japanese Patent Laid-open Publication No. 2007-203762 discloses a mounting device for a lighting device in which a light guide tube is attached around a peripheral edge of an automobile headlamp in a substantially circular shape. This light guide tube is formed as a soft and flexible round rod made of acrylic resin, and one end thereof is inserted in a tube case and connected to a light source within the tube case. Further, the entire light guide tube is inserted in the tube cover, and the tube cover is installed to a lamp lens with adhesive tape.

Japanese Patent Laid-open Publication No. 2011-240811 discloses a configuration for a lighting device in which a light guide rod is provided along a reverse surface of a vehicle door trim, and a case having an LED accommodated therein is installed on one end of the light guide rod. Further, the light guide rod is connected to the LED within the case, and light is emitted outside from an outer peripheral surface of the light guide rod. Also, a cap member, which is to be fixed to the trim board, is attached to a tip of the light guide rod, and the light emitted from the end face of the light guide rod is reflected by a reflection member integrated in the cap member so as to illuminate inside the handle compartment. Japanese Patent Laid-open Publication No. 2013-222657 discloses a lighting device in which two light guide rods are integrally formed, and at the connecting portion between the two light guide rods, a protrusion for installing the lighting device to a lamp housing of a door mirror is formed in a rib-form.

The lighting devices shown in the above-mentioned conventional art are used for vehicles, and therefore are not suitable for use in audio equipments. In the case of audio equipments, noise prevention measure is important, and it is necessary to eliminate an influence of noise caused by a lighting device on the outside.

### SUMMARY OF THE INVENTION

In view of the foregoing prior art problems, it is an object of the present invention to provide an improved audio equipment having a linear lighting device of which influence of noise on the outside is minimized, as well as a bracket for the linear lighting device of the audio equipment.

In order to accomplish the above-mentioned object, the present invention provides an audio equipment which comprises: a housing; a linear opening formed in the housing; a linear light guide member installed to the housing in such a manner that at least one side thereof is exposed at the opening, at least one end of the light guide member being accommodated in the housing away from the opening; and a light source connected to at least one end of the light guide member.

According to the aforementioned audio equipment, because the light source is arranged inside the housing away from the opening, the influence of noise caused by the light source on the outside of the housing can be reduced. Although not necessarily limited to, an LED should preferably be adopted for the light source because of its low cost and long life. Considering the influence of noise, the configuration according to the invention is particularly effective for LED. Noted that, in the present specification, “linear” shape includes not only a long, rod-like shape having a round, rectangular, polygonal cross-sectional shape or the like but also a shape having a flat, strip-like cross-section as long as the length in a longitudinal direction is sufficient with respect to the cross-sectional shape and the shape is considered to be substantially linear. Further, the shape of the light guide member is not necessarily limited to straight shapes but also includes curved and bent shapes and the like. Also, when connecting light sources to both ends of the light guide member, the both ends of the light guide member shall be accommodated in the housing away from the opening.

In one embodiment, the light guide member may be formed by a flexible material. Accordingly, the light guide member can be bent at necessary locations when wired, and therefore routing of the light guide member is facilitated.

In one embodiment, an emission surface of the light source and an incident surface of the light guide member may be in surface contact with each other, and the light guide member may have a flexure portion formed by elastic deformation of the light guide member in order to generate a pressing force in a longitudinal direction of the light guide member directed from the incident surface toward the emission by the flexure portion. According to the embodiment, by forming a flexure portion by elastic-deforming the flexible light guide member, the restoring force of the flexure portion can be acted on the incident surface as a pressing force in the longitudinal direction. Thus, the contact pressure between the emission surface and the incident surface of the light source can be increased, which leads to a reduction of a contact loss thereby.

In one embodiment, the audio equipment may further include a backing plate configured to support a rear side of the light guide member, which is on an opposite side of the side exposed at the opening, and groove portions may be formed respectively on both ends of the backing plate so as to engage with the light guide member extending inside the housing from both ends of the opening to retain the light guide member in a bent state at the groove portions. According to the embodiment, because the light guide member is supported by the backing plate, the installation work of the light guide member to the opening of the housing is facilitated. Also, because the light guide member is retained at the groove portion in the backing plate, the light guide member is prevented from being displaced from the opening.

In one embodiment, heat radiating holes may be formed on a portion of the housing and a light-shielding member may be provided between the light guide member in the housing and the heat radiating holes. In many audio equipments, heat radiating holes are formed to radiate heat in a bottom surface portion or the like of the housing. According to the embodiment, because the light-shielding member is provided to prevent leakage of light from the heat radiating holes, illumination at the opening can be made to stand out.

In one embodiment, at least one bridge may be provided at an intermediate position along a longitudinal direction of the opening, and the light guide member may be exposed at the opening in a state partially in contact with a rear surface of the bridge. According to the embodiment, in the state where the light guide member is arranged at the opening, the light guide member is partially in contact with the rear surface of the bridge and is pressed by the bridge. Therefore, even if there is some slackness in the light guide member, the light guide member can be stably arranged along the opening by being partially pressed at the bridge locations. This bridge portion also functions as a protection for the light guide member against impact from outside or the like.

In one embodiment, a width of the opening may be narrower than a width of the light guide member. According to the embodiment, when the light guide member is arranged at the opening, only one side of the light guide member will be exposed at the opening due to the small width of the opening. Accordingly, the light guide member can be exposed throughout an entire region of the opening without any problem even if there is any positional deviation in the arrangement of the light guide member. Further, the light guide member will be in a state pressed by both side edges of the opening. Accordingly, even if there is some slackness in the light guide member, the light guide member can be arranged in line along the opening linearly when arranged at the opening of the housing.

In order to accomplish the above-mentioned object, the present invention further provides a bracket for retaining a linear light guide member at a linear opening formed in a housing of an audio equipment in a state where at least one side of the linear light guide member is exposed, which comprises: a backing plate configured to support a rear side of the light guide member, which is on an opposite side of the side exposed at the opening; and groove portions formed respectively on both ends of the backing plate so as to engage with the light guide member extending inside the housing from both ends of the opening to retain the light guide member in a bent state at the groove portions.

In one embodiment, the bracket may further include a shelf plate portion connected to the backing plate and configured to mount the light guide member thereon so as to shield downward light leaked from the light guide member in the housing. In one embodiment, the shelf plate portion may form a right angle with respect to the backing plate.

In one embodiment, the shelf plate portion may includes side guide plates configured to retain both ends of the light guide member respectively and an end plate configured to retain a coupler for connecting an end of the light guide member to a light source.

According to the invention, linear illumination can be provided via the light guide member facing the linear opening of the housing, and since the light source is accommodated in the housing away from the opening, the audio equipment with small influence of the noise on the outside can be obtained.

### BRIEF DESCRIPTION OF DRAWINGS

Certain preferred embodiments of the present invention will hereinafter be described in detail, by way of example only, with reference to the accompanying drawings, in which:

FIG. 1 is an exploded perspective view of main components, ie, a lighting device and an opening of a housing, of an audio equipment according to an embodiment of the present invention;

FIG. 2 is a longitudinal sectional view illustrating a structure for installing the lighting device to the housing of the audio equipment;

FIG. 3 is a plan view illustrating a state where the lighting device is installed on the housing;

FIG. 4 is a perspective view illustrating an overall appearance of the audio equipment;

FIG. 5 is an enlarged cross-sectional view illustrating a state where the light guide member is disposed on the opening of the housing;

FIG. 6 is an exploded perspective view of the lighting device;

FIG. 7 is a plan view of the lighting device; and

FIG. 8 is a perspective view of the light guide member and a light source in a state removed from a bracket of the lighting device.

### DETAILED DESCRIPTION

An audio equipment 1 is, as an overall appearance thereof being shown in FIG. 4, a mixer device used for mixing of audio signals, and the audio equipment 1 is used in a state where it is mounted on a table surface 2 or the like. The audio equipment 1 has formed thereon, at an upper surface portion of a housing 10 thereof, a flat panel portion 11 provided with a plurality of columns of channel strips having a plurality of fader controller knobs 3 that adjust parameter values for audio signal processing in input channels, and a slanted panel portion 13 on which displays 12 and controller knobs or the like, not shown, are arranged side by side. A human operator is situated on a front side (right-hand side toward the front in FIG. 4) of the flat panel portion 11, and the slanted panel portion 13 is arranged toward a rear side of the flat panel portion 11. The human operator operates the respective controller knobs or the like of both of the panel portions 11, 13. Hereinafter, unless otherwise specified, a front-rear direction, a right-left direction, and an up-down direction as seen from the human operator will be regarded as the front-rear direction, the right-left direction, and the up-down direction of the audio equipment. In FIG. 4, the front-rear direction is shown as an X-direction, the right-left direction is shown as a Y-direction, and the up-down direction is shown as a Z-direction.

The flat panel portion 11 is formed substantially parallel to an installation surface portion 14, which configures a bottom surface of the audio equipment 1, at a predetermined height therefrom. At a front end of the flat panel portion 11, a continuous front surface portion 15 is provided so as to protrude forward from a front end of the installation surface portion 14. A front end of the front surface portion 15, that is, the front end of the flat panel portion 11, is formed as a convex arc-like surface so that it may function as a so-called hand rest or an arm rest. Also, on a back side of the front surface portion 15, a recessed groove portion 16 that is open downwardly and extends along the right-left direction so that it can serve as a handle by which one holds the audio equipment 1.

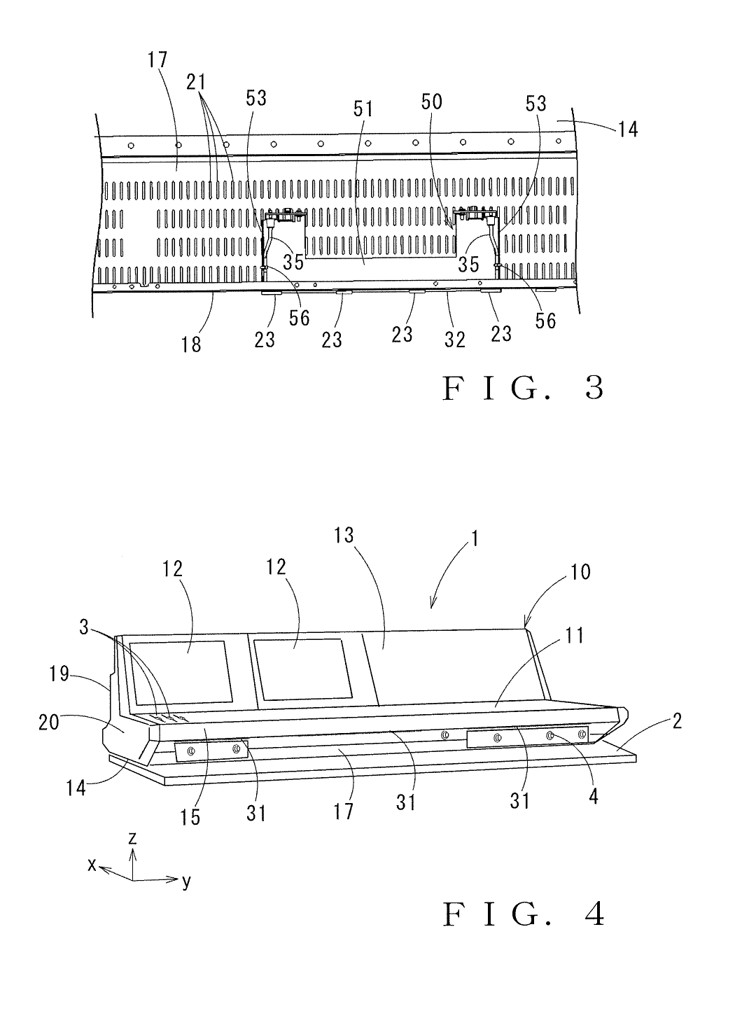

Further, at the front end of the installation surface portion 14, a slanted surface portion 17 is continuously formed such that a height thereof gradually increases from the installation surface portion 14. Between a front end of the slanted surface portion 17 and a rear end of the recessed groove portion 16 is formed a front wall portion 18 that extends along the up-down direction. In other words, the housing 10 of the audio equipment 1 according to the present embodiment has formed thereon, in order, starting from the installation surface portion 14, the slanted surface portion 17, the front wall portion 18, the recessed groove portion 16, the front surface portion 15, the flat panel portion 11, the slanted panel portion 13, and the rear surface portion 19. Side surface portions 20 are formed to cover both sides of the foregoing portions. Also, many heat radiating holes 21 (holes for ventilation) are provided penetrating through the slanted surface portion 17 (see FIG. 3) so that heat generated in the housing 10 can be released outside.

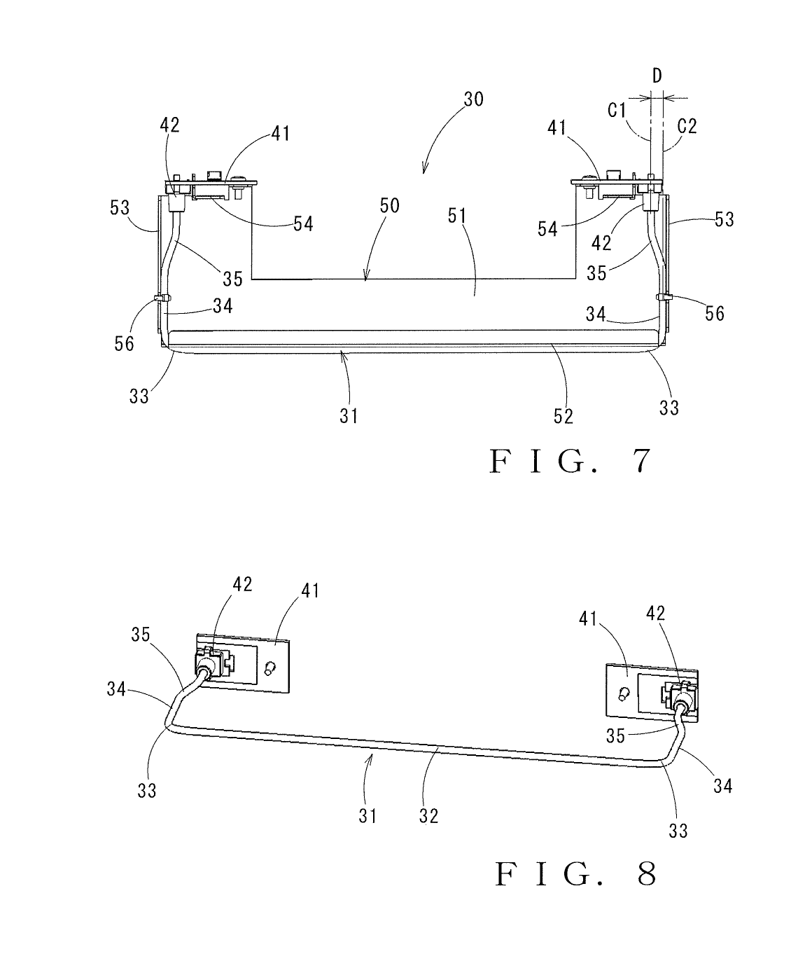

In the front wall portion 18 of the housing 10 and below the recessed groove portion 16, a straight opening 22 extending in the right-left direction (horizontal direction) is provided at a location hidden from the human operator by the front surface portion 15. As shown in FIG. 1, a plurality of openings 22 are formed at a predetermined interval in a longitudinal direction thereof, and light emitted by a lighting device 30 is irradiated linearly toward outside through the openings 22. As shown in FIG. 1 and FIGS. 6 through 8, the lighting device 30 is provided with a linear light guide member 31, a substrate 41 having a light source 40, a coupler 42 that connects the light guide member 31 and the light source 40 on the substrate 41, and a bracket 50 that retains the light guide member 31 and the substrate 41 having fixed thereon the light source 40 and the coupler 42.

The light guide member 31 is formed by a light permeable material such as acrylic resin into a linear shape such as a long rod having softness and flexibility. The light guide member 31 functions as a linear light source throughout an entire length thereof in a longitudinal direction when light enters from an end face of the light guide member 31 and the light propagates in the longitudinal direction while reflecting on an outer peripheral surface of the light guide member 31, and a part of the light is emitted outside through the outer peripheral surface. While a cross section of the light guide member 31 in the present embodiment is formed as a circle, the cross section thereof also may be in such shapes as a rectangular shape, a polygonal shape or the like. The light guide member 31 may also be a strip having a flat (or squashed) cross section, in so far as the shape is substantially linear.

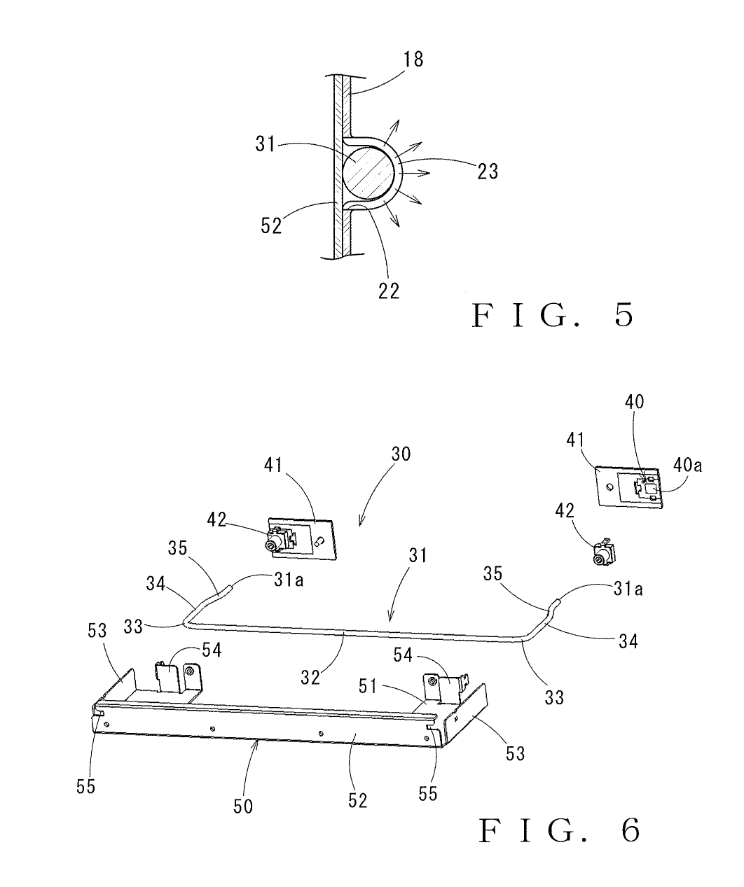

The light guide member 31 is retained by the bracket 50 in a state bent into a predetermined shape, and the light guide member 31 is installed on the housing 10 as described later. Specifically, as shown in FIGS. 6 through 8, an intermediate portion of the light guide member 31 in the longitudinal direction is maintained straight such that one side thereof faces the aforementioned opening 22 of the housing 10 and forms a straight portion 32. At both ends of the straight portion 32, the light guide member 31 is bent at a right angle to form bent portions 33, and lead-out ends 34 extend from the bent portions 33 substantially parallel to each other.

The bracket 50 is configured to retain the light guide member 31, and a backing plate 52 that supports a rear side of the straight portion 32, side guide plates 53 that respectively retain both of the lead-out ends 34, and end plates 54 that respectively retain the respective substrates 41 are formed by pressing a metal sheet such that the respective plates are erected vertically with respect to a shelf plate portion 51 which is arranged horizontally (see FIG. 6). In this case, the backing plate 52 and the both side guide plates 53 are provided at a right angle, the both side guide plates 53 are provided parallel to each other, and the both end plates 54 provided at a right angle with respect to the both side guide plates 53. Accordingly, both the end plates 54 and the backing plate 52 are arranged parallel to each other.

Also, on both ends of the backing plate 52, groove portions 55 that engage with the respective intermediate positions of the bent portions 33 of the light guide member 31 are formed. When the bent portion 33 of the light guide member 31 engages with the respective groove portion 55, the both lead-out ends 34 of the light guide member 31 are arranged above the shelf plate portion 51, and the lead-out ends 34 are retained by the respective side guide plates 53 above the shelf plate portion 51. Further, in the present embodiment, binders 56 for fixing the lead-out ends 34 of the light guide member 31 to the respective side guiding plates 53 of the bracket 50 are provided.

Also, on the end plate 54, the substrate 41 having an LED as the light source 40 is fixed, and the coupler 42 installed on the substrate 41 connects the light guide member 31 and the light source 40. As shown in FIG. 6, the end face of the light guide member 31 is an incident surface 31a, and the coupler 42 brings into contact an emission surface 40a of the light source (LED) 40 and an incident surface 31a of the light guide member 31 such that the emission surface 40a and the incident surface 31 a make a surface contact with each other so that the ends of the light guide member 31 are retained.

Further, in order to generate a pressing force in the longitudinal direction of the light guide member 31 for pressing the incident surface 31a of the light guide member 31 against the emission surface 40a of the light source 40 inside the coupler 42, a flexure portion 35 formed by elastic deformation of the light guide member 31 is formed between the coupler 42 and a portion of the lead-out portion 34 of the light guide member 31 where the lead-out portion 34 is bundled by the binder 56. Specifically, as shown in FIG. 7, a retaining axis C1 of the coupler 42 provided in the end plate 54 is displaced in a horizontal direction from a central axis C2 of the light guide member 31 at the portion retained on the side guide plate 53 by the binder 56. In addition, the length of the light guide member 31 is made slightly longer than a length required between the two couplers 42 in the bracket 50, and as a result, the flexure portion 35 is formed by elastic deformation of the light guide member 31 that is produced by a difference D between the axes C1 and C2. Because of a restoring force of the flexure portion 35, the incident surface 31a of the light guide member 31 is pressed against the emission surface 40a of the light source 40. Accordingly, a contact pressure between the light source 40 and the light guide member 31 can be increased, which leads to a reduction of a contact loss.

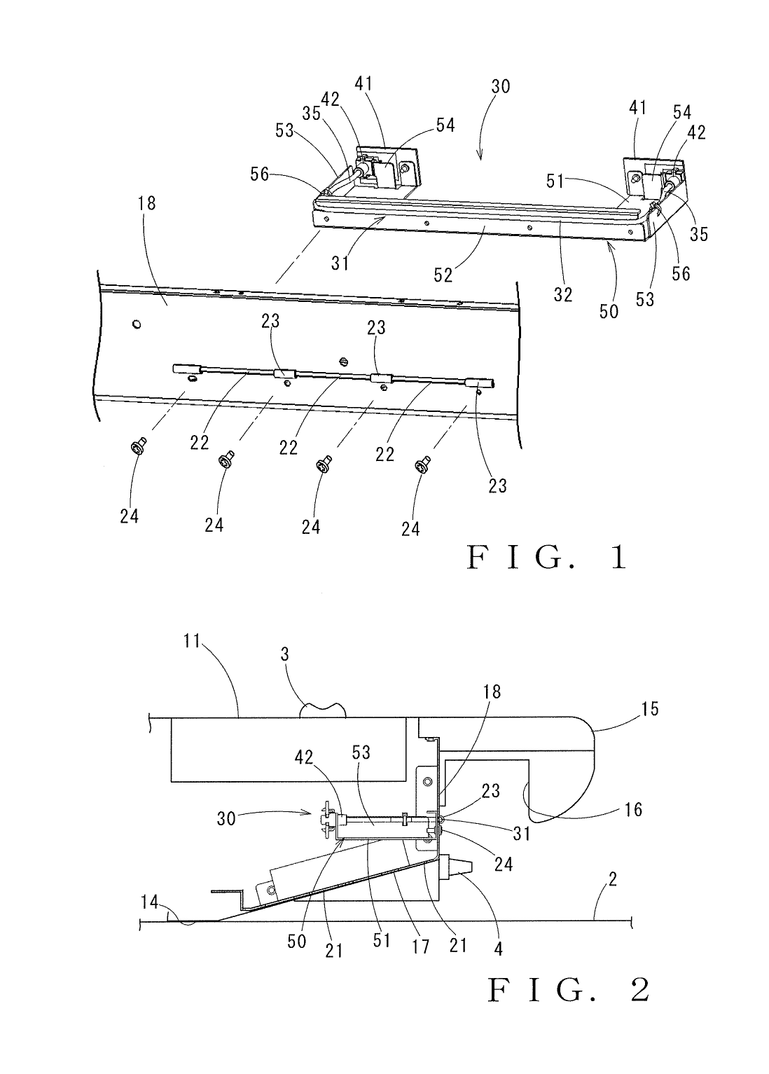

On the other hand, the opening 22 of the front wall portion 18 of the housing 10 is open at a width substantially the same as or slightly greater than the diameter of the light guide member 31. At a plurality of intermediate locations along the longitudinal direction of the opening 22, as shown in FIG. 1 and FIG. 5, half-cylindrical bridge portions 23 each connecting a portion of both side edges of the opening 22 are provided. Because a plurality of bridge portions 23 are provided at intervals, the opening 22 is formed intermittently. By retaining the light guide member 31 with the bracket 50 and fixing the backing plate 52 of the bracket 50 to a rear surface of the front wall portion 18 via screws 24 (see FIG. 1), the straight portion 32 of the light guide member 31 is exposed at the opening 22, and at the same time, the light guide member 31 contacts a rear surface of the bridge portions 23 at a plurality of locations in the longitudinal direction thereof. Thus, the light guide member 31 is stably arranged by being intermittently pressed by the bridge portions 23. Also, in this installation state, the shelf plate portion 51 of the bracket 50 is retained on the rear surface of the front wall portion 18 at a right angle thereto in a direction away from the rear surface, as shown in FIG. 2. Note that, a reference numeral 4 in FIG. 4 illustrates a headphone volume dial, an output terminal to which headphones are connected, etc.

In the audio equipment 1 configured as such, by retaining the light guide member 31 and the light source 40 by the bracket 50 and fixing the bracket 50 to the rear surface of the front wall portion 18 of the housing 10, the straight portion 32 of the light guide member 31 can be exposed at the opening 22 of the front wall portion 18. In this case, since the light guide member 31 is flexible, it is easy to route the light guide member 31 when installing it to the bracket 50. Also, when the light guide member 31 is installed, even if the light guide member 31 is supported by the both groove portions 55 of the backing plate 52 in a slightly slack state at a front surface of the backing plate 52, the rear side of the straight portion 32 of the light guide member 31 is supported by the backing plate 52 from behind while the straight portion 32 is made to face the opening 22, and the bracket 50 is fixed to the front wall portion 18 such that the straight portion 32 is held between the bridge portions 23 and the backing plate 52 to be retained straight. Further, although the light guide member 31 is pressed during the installation, because both ends of the straight portion 32 are engaged with the groove portions 55 in the backing plate 52, the straight portion 32 is arranged accurately facing the opening 22 without being displaced in a width direction. Accordingly, the light guide member 31 can be easily installed at a correct position by merely fixing the bracket 50 retaining the light guide member 31 or the like to the front wall portion 18 of the housing 10 by screws or the like.

Further, in a state where the light guide member 31 is fixed to the housing 10 by the bracket 50, when light enters the light guide member 31 from the light source 40, the light is irradiated outside from the linear light guide member 31 (straight portion 32) facing the opening 22 of the front wall portion 18 at a lower-front portion of the housing 10. Accordingly the top of the table surface 2 located to the front of the housing 10 can be illuminated, the light guide member 31 functioning as a lamp for lighting an area around one's hands such as when an operator reads a script in front of the audio equipment 1 or when the human operator operates a recorder, a keyboard, and the like. Alternatively, in the case of the present embodiment, the light guide member 31 may be made to function as a guide light when plugging a plug into a headphone output terminal 4. In this case, as described earlier, the opening 22 is formed at a position that cannot be directly seen from above the front surface portion 15, so that it is less likely to interfere with audience's viewing during a concert, an event, or the like when it is used near the audience seats. Further, because the light guide member 31 gives off a soft light similar to an indirect lighting, it offers an enhanced designability.

Also, an LED is used as the light source 40 which is connected to the light guide member 31. Because the LED is liable to generation of noise due to a PMW control for modulation, the influence of the noise may cause a problem. However, the light source 40 is arranged at a distance from the front wall portion 18 of the housing 10 by the bracket 50, the influence of noise of the light source 40 on the exterior of the housing 10 can be reduced.

Further, in the housing 10, the aforementioned heat radiating holes 21 are formed in the slanted surface portion 17 in addition to the opening 22. The both lead-out ends 34 of the light guide member 31 arranged in the housing 10 are arranged above the shelf plate portion 51 of the bracket 50, and the shelf plate portion 51 is arranged between the slanted surface portion 17 and the lead-out ends 34 of the light guide member 31 such that it blocks the slanted surface portion 17 from the lead-out ends 34, the shelf plate portion 51 functioning as a light-shielding member for shielding downward light leaked from the lead-out ends 34 of the light guide member 31. Accordingly, leakage of light emitted by the lead-out ends 34 from the heat radiating holes 21 in the slanted surface portion 17 to the outside can be prevented.

Further, the straight portion 32 of the light guide member 31 facing the opening 22 is covered by the bridge portions 23 at a plurality of locations in the longitudinal direction so that the bridge portions 23 act as a protector for the light guide member 31 and prevent damage in case of impact from outside or the like.

Note that, the invention is not limited to the above-mentioned embodiments, and therefore, various modifications thereof are possible within a scope not departing from the spirit of the invention. For example, in the embodiment, when the light guide member is exposed from the opening of the housing, the width of the opening is set substantially the same as or slightly greater than the diameter of the light guide member, and the light guide member is pressed by the bridge portion, however, the width of the opening may be made smaller than the diameter of the light guide member such that the side edge of the opening contacts the light guide member, omitting the bridge portions. Also, while in the embodiment, the light sources are connected to both ends of the light guide member, the light source may be connected to only one end face. In that case, a reflection film may be formed on the other end face of the light guide member.

Further, when the heat radiating holes formed in the housing are provided on the other surfaces such as the side plate instead of on the slanted surface portion according to the embodiment, a light-shielding member may be arranged in the bracket such that it blocks the light guide member from the heat radiating holes. Further, the shape and material of the bracket are not limited to those shown in the embodiment, in so far as the bracket can support the light guide member and a light-shielding member can be arranged therein in the case where heat radiating holes are formed in a portion of the housing. Regarding the installation structure of the bracket to the housing, various structures such as fixation by screw, fixation by adhesive, and engagement onto hooks made of elastic pieces can be adopted. While the audio equipment in the above-mentioned embodiment is a mixer device, needless to say, the invention can be applied to audio equipment other than a mixer device.

This application is based on, and claims priority to, JP PA 2014-048644 filed on 12 Mar. 2014. The disclosure of the priority application, in its entirety, including the drawings, claims, and the specification thereof, are incorporated herein by reference.

What is claimed is:

1. An audio equipment comprising:
a housing;
a linear opening formed in the housing;
a linear light guide member installed in the housing in such a manner that at least one side thereof is exposed at the opening, at least one end of the light guide member being accommodated in the housing away from the opening; and
a light source connected to at least one end of the light guide member.

2. The audio equipment according to claim 1, wherein the light guide member is formed by a flexible material.

3. The audio equipment according to claim 2, wherein an emission surface of the light source and an incident surface of the light guide member are in surface contact with each other, and the light guide member has a flexure portion formed by elastic deformation of the light guide member in order to generate a pressing force in a longitudinal direction of the light guide member directed from the incident surface toward the emission by the flexure portion.

4. The audio equipment according to claim 2, further comprising a backing plate configured to support a rear side of the light guide member, which is on an opposite side of the side exposed at the opening, wherein groove portions are formed respectively on both ends of the backing plate so as to engage with the light guide member extending inside the housing from both ends of the opening to retain the light guide member in a bent state at the groove portions.

5. The audio equipment according to claim 1, wherein heat radiating holes are formed on a portion of the housing and a light-shielding member is provided between the light guide member in the housing and the heat radiating holes.

6. The audio equipment according to claim 1, wherein at least one bridge is provided at an intermediate position along a longitudinal direction of the opening, and the light guide member is exposed at the opening in a state partially in contact with a rear surface of the bridge.

7. The audio equipment according to claim 1, wherein a width of the opening is narrower than a width of the light guide member.

8. A bracket for retaining a linear light guide member at a linear opening formed in a housing of an audio equipment in a state where at least one side of the linear light guide member is exposed, the bracket comprising:
a backing plate configured to support a rear side of the light guide member, which is on an opposite side of the side exposed at the opening; and
groove portions formed respectively on both ends of the backing plate so as to engage with the light guide member extending inside the housing from both ends of the opening to retain the light guide member in a bent state at the groove portions.

9. The bracket according to claim 8, further comprising a shelf plate portion connected to the backing plate and configured to mount the light guide member thereon so as to shield downward light leaked from the light guide member in the housing.

10. The bracket according to claim 9, wherein the shelf plate portion forms a right angle with respect to the backing plate.

11. The bracket according to claim 9, wherein the shelf plate portion comprises side guide plates configured to retain both ends of the light guide member respectively and an end plate configured to retain a coupler for connecting an end of the light guide member to a light source.
